(19) United States
(12) Patent Application Publication
(10) Pub. No.: US 2002/0113140 A1
(43) Pub. Date: Aug. 22, 2002

(54) Fuel injection apparatus for an internal combustion engine

(76) Inventor: Matthias Beck, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/030,984

(22) PCT Filed: May 3, 2001
(86) PCT No.: PCT/DE01/01680

(30) Foreign Application Priority Data
May 16, 2000 (DE) 100 23 960.9

(51) Int. Cl. F02M 47/02

(52) U.S. Cl. 239/88

(57) ABSTRACT

The fuel injection apparatus has a pump unit (39), which pumps fuel at high pressure into a high-pressure conduit (10) communicating with an injection valve (1), and having a control valve (11), in which a pistonlike valve member (14) is guided with a sealing portion (114) in the bore (26), the sealing portion (114) being surrounded by a high-pressure chamber (16) that communicates with the pump work chamber (48). With one end, the valve member (14) protrudes one low-pressure chamber (18), which communicates with a fuel delivery system (58). A valve seat (22) is embodied in the bore (26) and cooperates with a valve sealing face (24), embodied on the valve member (14), to control the communication between the high-pressure chamber (16) and the low-pressure chamber (18). In terms of the fuel flow direction from the high-pressure chamber (16) to the low-pressure chamber (18), a throttle portion (21) is embodied in the bore (26) upstream of the valve seat (22) and with the sealing portion (114) of the valve member (14) forms a throttle gap (23), thus upon the opening stroke motion throttling the fuel flow in a stroke range of the valve member (14), so that upon the opening stroke motion of the valve member (14), no additional hydraulic forces can act on the valve member (14).

### PRIOR ART

The invention is based on a fuel injection apparatus for an internal combustion engine. One such fuel injection apparatus in the form of a unit fuel injector is known from German Patent Disclosure DE 35 23 536 A1. For each combustion chamber of the engine, one unit fuel injector is provided, in which a pump unit, a control valve, and an injection valve are integrated to form a unit. The pump unit comprises a pump piston, which is driven synchronously with the engine and plunges into a pump work chamber, where it positively displaces the fuel located at high pressure therein. The pump work chamber communicates with the fuel injection apparatus, which opens at a certain fuel pressure and thus injects fuel at high pressure into the combustion chamber of the engine.

The control valve disposed in the housing of the unit fuel injector opens and closes a communication between the pump work chamber and a fuel delivery system, in which a low fuel pressure prevails and which not only delivers fuel to the unit fuel injector but also receives excess fuel. Once the control valve is open, the fuel is carried out of the pump work chamber into the fuel delivery system, so that no fuel pressure can build up in the injection valve and thus no injection occurs. When the control valve closes, a corresponding pressure can build up, and fuel is injected into the combustion chamber of the engine. In this way, the onset of injection and, by way of the duration of injection, the injected fuel quantity as well can be controlled. The valve member is urged by a spring in the opening direction, and by a controllable counterforce, here brought to bear by an electromagnet, it is kept in the closing position. If the electromagnet is switched off, then the spring presses the valve member in the opening direction, and the communication from the high-pressure region into the low-pressure region is opened.

In one exemplary embodiment shown in DE 35 23 536 A1, the valve member of the control valve has a valve seat and a throttle collar on the valve member; this collar is downstream in terms of the flow direction from the high-pressure region to the low-pressure region and makes the flow cross section within a certain region largely independent of the stroke of the valve member. As a result, it is possible to establish a throttled fuel flow from the high-pressure chamber into the low-pressure chamber.

However, the known valve member has the disadvantage that upon the opening of the valve member, a hydraulic force acts on the valve sealing face, and over the course of the opening stroke motion of the valve member this force is added to the opening force of the spring. This makes it difficult to regulate the counterforce of the electromagnet in accordance with requirements, that is, in such a way that the valve member is kept in a position in which the flow of fuel is throttled.

Advantages of the Invention

The unit fuel injector according to the invention with the definitive characteristics of the body of claim 1 has the advantage over the prior art that no additional hydraulic forces that have to be compensated for by the opening mechanism act on the valve member in the throttling position. The valve member has a relatively large stroke range in which the flow cross section is independent of the stroke. The throttle gap is formed between a cylindrical portion of the bore and the valve member and is upstream of the valve seat, in terms of the fuel flow direction from the high-pressure chamber to the low-pressure chamber. The fuel flow from the high-pressure chamber is carried first through this throttle gap and then past the valve sealing face to the low-pressure chamber, so that a low fuel pressure already prevails at the valve sealing face. As a result, no or only insignificant hydraulic forces that are superimposed on the opening force on the valve member act on the valve sealing face. The valve member can thus in an easily controlled way approach not only an opened and a closed position but also a third, throttling position, making a preinjection at lower pressure through the injection valve possible.

### DRAWING

In the drawing, one exemplary embodiment of the fuel injection apparatus of the invention is shown. Shown are

FIG. 1, a longitudinal section through a fuel injection apparatus;

FIG. 2, an enlargement of FIG. 1 in the region of a control valve; and

FIG. 3, a schematic illustration of the throttle cross section, opened by the control valve, as a function of the stroke of the valve member.

### DESCRIPTION OF THE EXEMPLARY EMBODIMENT

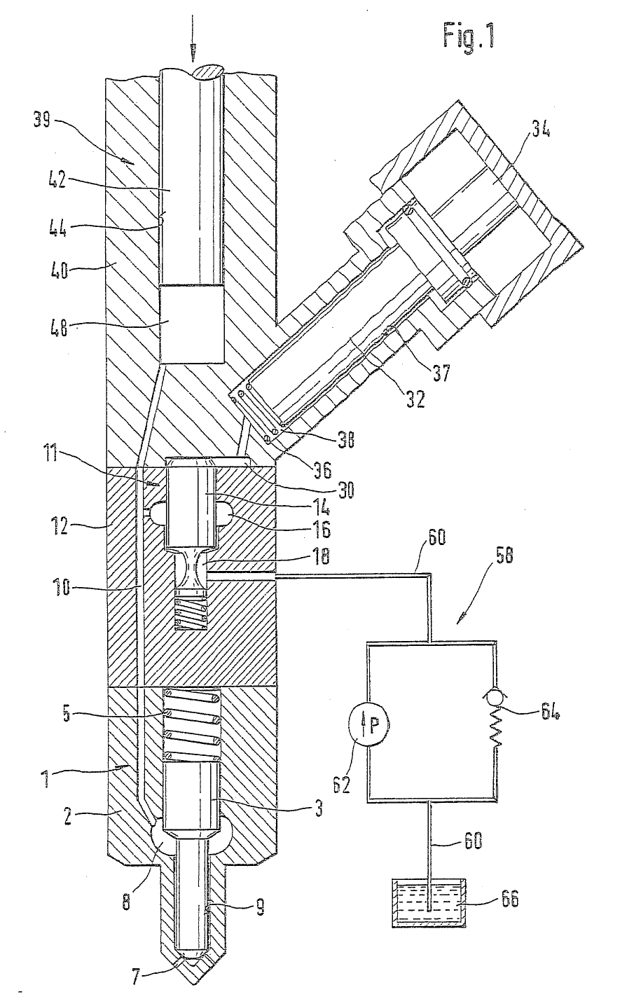

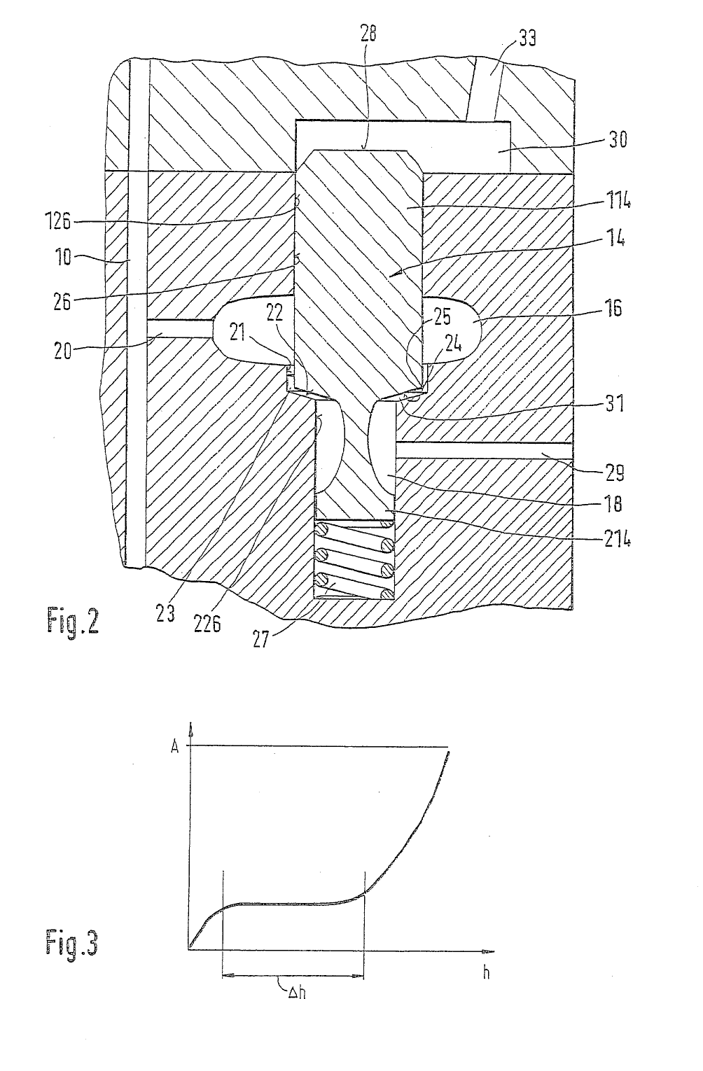

In FIG. 1, a longitudinal section is shown through a fuel injection apparatus of the invention, in the form of a unit fuel injector, of the kind used to inject fuel into the combustion chamber of an internal combustion engine, in particular a self-igniting internal combustion engine. The unit fuel injector contains all the components necessary for an injection; that is, a high-pressure-generating pump unit 39, an injection valve 1, and a control valve 11, which controls the onset and end of the injection. For the sake of clarity, FIG. 2 shows an enlargement of FIG. 1 in the region of the control valve 11. The structure of the individual components will be explained first below, and then their function as part of the unit fuel injector will be described.

The injection valve 1 includes an injection valve body 2, which is embodied essentially as a cylinder with a stepped diameter and protrudes with one end as far as the inside of the combustion chamber of an internal combustion engine, not shown in the drawing. A blind bore 9 is embodied in the injection valve body 2, and its closed end is toward the combustion chamber; on that end, there is at least one injection opening 7, which connects the blind bore 9 with the combustion chamber of the engine. A valve needle 3 is disposed in the blind bore 9; it is longitudinally displaceable counterto the force of a closing spring 5 and by means of its opening stroke motion opens and closes the at least one injection opening 7. The valve needle 3 is surrounded by a pressure chamber 8, embodied in the injection valve body 2, that continues in the form of an annular conduit, surrounding the valve needle 3, as far as the injection openings 7 and that can be filled with fuel at high pressure via a high-pressure conduit 10 embodied in the injection valve body 2.

Remote from the combustion chamber toward the injection valve body 2, there is a cylindrical valve body 12, which rests with one face end on the injection valve body 2 and whose other face end, remote from the combustion chamber, comes to rest on a pump body 40; the injection valve body 2, valve body 12 and pump body 40 are braced axially against one another by a device not shown in the drawing. The high-pressure conduit 10 embodied in the injection valve body 2 continues in the axial direction through the entire valve body 12 as far as the inside of the pump body 40. In the valve body 12, there is a bore 26, embodied as part of the control valve 11 in the axial direction, which is divided into a larger-diameter sealing portion 126 and a smaller-diameter guide portion 226 that is closed toward the combustion chamber; an annular shoulder acting as valve seat 22 is formed at the transition between the two portions 126, 226. A valve member 14 is disposed in the bore 26; it is guided sealingly in the sealing portion 126 of the bore 26 and tapers toward the combustion chamber, forming a valve sealing face 24, and then protrudes as far as the inside of the guide portion 226 of the bore 26. Toward the end of the valve member 14 nearer the combustion chamber, it increases in diameter again and merges with a portion 214, which is guided in the guide portion 226 of the bore 26. Between the valve member 14 and the end of the bore 26 toward the combustion chamber, a spring 27 is disposed with initial tension and urges the valve member 14 away from the combustion chamber.

A high-pressure chamber 16 embodied in the valve body 12 surrounds the sealingly guided portion 114 of the valve member 14 and communicates with the high-pressure conduit 10 via a connecting bore 20. The control valve 11 opens and closes the communication with a low-pressure chamber 18, formed by the narrowing of the valve member 14 between the portions 114 and 214 of the valve member 14 on the one hand and by the guide portion 226 of the bore 26 on the other. The low-pressure chamber 18 communicates with a fuel delivery system 58 via an inlet conduit 29. The fuel delivery system 58 includes a tank 66, from which fuel is pumped into the low-pressure chamber 18 by means of a feed pump 62 via a low-pressure line 60. Parallel to the feed pump 62 is an overpressure valve 64, which assures that if a certain threshold pressure is exceeded, the fuel from the low-pressure chamber 18 can flow back into the tank 66.

The end face 28, remote from the combustion chamber, of the valve member 14 protrudes as far as the inside of a control chamber 30, which is filled with fuel and is embodied in a pump body 40. Via the fuel pressure in the control chamber 30, a hydraulic force can be brought to bear on the end face 28 of the valve member 14, which force is oriented counter to the force of the spring 27, so that the valve member 14 can be moved longitudinally in the bore 26, controlled by the fuel pressure in the control chamber 30.

The control chamber 30 communicates via a connecting bore 33 with a spring chamber 38, which spring chamber 38 is defined by the closed end of a guide bore 37 and by the end face of a control piston 32 that is guided sealingly and longitudinally displaceably in the guide bore 37. The control piston 32 is acted upon by a restoring spring 36, disposed in the spring chamber 38 with initial tension, and is connected on its end face remote from the spring chamber 38 to a piezoelectric actuator 34, which can change its expansion by means of a suitable supply of electric current and can thus move the control piston 32 in the guide bore 37. The control piston 32, upon its longitudinal motion, positively displaces fuel out of the spring chamber 38 and forces the fuel via the connecting bore 33 into the control chamber 30, so that the pressure and thus also the hydraulic force on the end face 28 of the valve member 14 vary there accordingly.

Between the valve seat 22 and the high-pressure chamber 16, a throttle portion 21 is embodied in the bore 26; compared to the sealing portion 126 of the bore 26, this portion has an even somewhat larger diameter. As a result, a narrow throttle gap 23 embodied as an annular gap is formed between the throttle portion 21 of the bore 26 and the jacket face of the valve member 14. For controlling the fuel flow from the high-pressure chamber 16 to the low-pressure chamber 18, along with the closed and the open position of the valve member 14 still another position is obtained: When the control edge 25, formed at the transition from the sealing portion 114 to the valve sealing face 24, is located inside the throttle portion 21 of the bore 26, the fuel flow from the high-pressure chamber 16 to the low-pressure chamber 18 takes place in throttled fashion. If in the course of the opening stroke motion of the valve member 14 the control edge 25 emerges from the throttle portion 21, the result is free flow of fuel out of the high-pressure chamber 16 into the low-pressure chamber 18.

If the throttle cross section A that is opened up by the valve member 14 is plotted against the stroke h of the valve member 14, the result is the graph shown schematically in FIG. 3, in which when the valve sealing face 24 is in contact with the valve seat 22, the stroke h should be zero. At the beginning of the opening stroke motion, the control gap 31 that is forming between the valve sealing face 24 and the valve seat 22 has a smaller throttle cross section than the throttle gap 23. The opened throttle cross section A thus increases with the stroke h, until the throttle cross section of the control gap 31 reaches that of the throttle gap 23. From that point on, the size of the throttle cross section A increases only slightly with an increasing stroke h, since the throttle cross section A is determined by the throttle gap 23, and thus the downstream control gap 31 does not play any major role for the throttle cross section of the fuel and thus for the flow resistance. This plateau range of the stroke h is indicated as Δh in FIG. 3 and defines the operating range of the control valve 11, in which the valve member 14 builds up a preinjection pressure in the high-pressure conduit 10 that is reduced compared to the pressure established when the control valve 11 is closed. Because of the throttle portion 21, the range Δh is quite large, so that the triggering of the valve member 14 for the preinjection can be done reliably, since instead of a precisely determined stroke h, only a stroke that is within the stroke range Δh has to be approached.

A pump bore 44 extending essentially longitudinally of the pump body is embodied in the pump body 40; it is closed toward the combustion chamber, and a pump piston 42 is guided longitudinally displaceably in it. Between the end face of the pump piston 42, toward the combustion chamber, and the closed end of the pump bore 44, a pump work chamber 48 is formed, into which the high-pressure conduit 10 discharges. The pump piston 42 is set into longitudinal motion in the bore 44 at the pace of the injection via a mechanism not shown in the drawing, such as a camshaft driven by the engine; in the pumping motion toward the pump work chamber 48, the pump piston 42 positively displaces the fuel out of the pump work chamber 48 and forces it at high pressure into the high-pressure conduit 10.

The mode of operation of the unit fuel injector is as follows: At the onset of injection, the pressure in the control chamber 30 is low, since the piezoelectric actuator 34 is not receiving electric current. As a result, the hydraulic force on the end face 28 of the valve member 14 is less than the force of the spring 27, and the valve member 14 rests with its end face 28 on the wall of the control chamber 30, so that the valve sealing face 24 is lifted from the valve seat 22. As a result, the communication from the high-pressure chamber 16 to the low-pressure chamber 18 is open, and in the high-pressure conduit 10, the low fuel pressure generated by the feed pump 62 prevails. The pump piston 42 is at its upper turning point, and thus the pump work chamber 48 is at its maximum volume.

By means of a mechanism not shown in the drawing, the pump piston 42 is moved into the pump work chamber 48, so that it compresses the fuel located in the pump work chamber 48 and positively displaces it into the high-pressure conduit 10. Shortly after the onset of this pumping stroke of the pump piston 42, current is delivered to the piezoelectric actuator 34, so that the pump piston changes its length and moves the control piston 32 into the spring chamber 38, counter to the force of the restoring spring 36. The fuel thus positively displaced out of the spring chamber 38 raises the fuel pressure in the control chamber 30, so that the force on the end face 28 of the valve member 14 is likewise increased accordingly, to such an extent that it becomes greater than the force of the spring 27. The supply of electric current to the piezoelectric actuator 34 is regulated in such a way that the control edge 25 plunges into the throttle portion 21 without the valve sealing face 24 coming into contact with the valve seat 22. The fuel, which at the onset of the pumping motion of the pump piston 42 can flow practically unthrottled out of the high-pressure conduit 10 into the low-pressure chamber 18 via the high-pressure chamber 16, is now throttled by the throttle gap 23, so that in the high-pressure chamber 16 and in the high-pressure conduit 10 a certain preinjection pressure is established, which depends on how high the pumping rate of the pump piston 42 is and how strong the throttling action of the throttle gap 23 is. The throttling of the fuel pressure takes place in the throttle gap 23, and thus the pressure in the fuel flow to the low-pressure chamber 18 has already dropped once the fuel reaches the valve sealing face 24. Thus only slight hydraulic forces on the valve sealing face 24 are produced, and hence no forces that are hard to control are exerted in the opening direction on the valve member 14. Such additional forces would have to be compensated for by the pressure in the control chamber 30, which would markedly impair the reliability of the control valve. Since thus essentially only the force of the spring 27 acts as an opening force, the throttling position of the valve member 14 can be approached with high precision via the pressure in the control chamber 30.

The preinjection pressure in the control edge 10 and thus also in the pressure chamber 8 of the injection valve 1 is adapted, with the force of the closing spring 5 that keeps the valve needle 3 in the closing position, in such a way that the hydraulic force on the valve needle 3 suffices to move the valve needle 3 in the opening position and thus to open the injection openings 7. Since the preinjection pressure is markedly below the maximum injection pressure, only a slight fuel quantity is injected into the combustion chamber (preinjection). For the main injection, the control piston 32 by means of the piezoelectric actuator 34 raises the pressure in the control chamber 30 further, until the valve member 14 in response to the hydraulic force on the end face 28 comes to rest with its valve sealing face 24 on the valve seat 22. The communication between the high-pressure chamber 16 and the low-pressure chamber 18 is thus interrupted, and the maximum pressure that could be generated by the pump piston 42 is operative in the high-pressure conduit 10 and in the pressure chamber 8. The injection now takes place at a markedly higher injection pressure and thus at a higher injection rate.

The main injection can be continued at the most until the pump piston 42 has reached its lower turning point, and all the fuel that can be positively displaced by the pump piston 42 has been pumped into the high-pressure conduit 10. Usually, however, the main injection is ended markedly earlier, since on the one hand less fuel is needed in the combustion chamber, and on the other a precisely defined end of the injection is a goal. This is achieved by providing that the pressure in the control chamber 30 is reduced, under the control of the piezoelectric actuator 34. The force of the spring 27 now predominates again over the hydraulic force on the end face 28 of the valve member 14, and the valve member 14 is moved in the direction of the control chamber 30 until it comes into contact with the wall of the control chamber 30. As a result, the high-pressure conduit 10 is also made to communicate with the low-pressure chamber 18 via the high-pressure chamber 16, so that the pressure in the pressure chamber 8 also drops, and the valve needle 3, by means of the closing spring 5, closes the injection openings 7. The remaining quantity of fuel that the pump piston 42 continues to pump after the termination of the injection, before the pump piston reaches the lower turning point, is pumped into the low-pressure line 60 and from there into the tank 66 via the overpressure valve 64.

In the ensuing reciprocating pumping motion of the pump piston 42 out of its lower turning point to the upper turning point, fuel is pumped by the feed pump 62 through the low-pressure line 60 and the inlet conduit 29 into the low-pressure chamber 18, from whence the fuel reaches the pump work chamber 48, via the high-pressure chamber 16, the connecting bore 20, and the high-pressure conduit 10. Once the pump piston 42 finally reaches its upper turning point, the injection cycle is concluded.

The disposition shown in the drawing of the valve member 14, control piston 32 and pump piston 44 relative to the injection valve 1 is not strictly necessary for the function of the unit fuel injector. Provision may also be made so that one or more of these elements is oriented in some other way—if that should be expedient. For instance, the valve member 14 and thus the bore 26 as well can also be disposed perpendicular to the longitudinal axis of the nozzle needle 3.

Besides the hydraulic control, shown in the drawing, of the closing force on the valve member 14 by means of a piezoelectric actuator, it is also possible for the closing force to be exerted by means of an electromagnet. Nor does the force of the piezoelectric actuator 34 have to be exerted via a hydraulic conversion; instead, it can also be exerted directly on the valve member 14.

1. A fuel injection apparatus for an internal combustion engine, having a pump unit (39) which pumps fuel at high pressure by positive displacement of the fuel out of a pump work chamber (48), and having a high-pressure conduit (10) by way of which the pump work chamber (48) communicates with an injection valve (1), having a control valve (11) which has a valve member (14) that is guided longitudinally displaceably by a cylindrical sealing portion (114) in a bore (26), the sealing portion (114) being surrounded by a high-pressure chamber (16) that communicates with the pump work chamber (48), and which valve member (14) protrudes with one end into a low-pressure chamber (18) that communicates with a fuel delivery system, and between the high-pressure chamber (16) and the low-pressure chamber (18) in the bore (26), a valve seat (22) is embodied which cooperates with a valve sealing face (24) embodied on the valve member (14) for controlling the communication between the high-pressure chamber (16) and the low-pressure chamber (18), wherein the closing motion of the valve member (14) is effected in the flow direction with regard to the direction of flow of the fuel from the high-pressure chamber (16) to the low-pressure chamber (18), characterized in that upstream from the valve seat (22) in the bore (26), a throttle portion (21) is embodied, so that a throttle gap (23) is formed between the throttle portion (21) and the jacket face of the valve member (14).

2. The fuel injection apparatus of claim 1, characterized in that the throttle portion (21) of the bore (26) extends from the valve seat (22) upstream as far as the inside of the high-pressure chamber (16).

3. The fuel injection apparatus of claim 1 or 2, characterized in that at the transition from the sealing portion (114) of the valve member (14) to the valve sealing face (24), a control edge (25) is embodied, which emerges from the throttle portion (21) of the bore (26) in the opening stroke motion.

4. The fuel injection apparatus of one of claims 1-3, characterized in that the valve seat (22) is embodied as an annular shoulder, which is formed by a radial narrowing of the bore (26) in the fuel flow direction.

5. The fuel injection apparatus of one of the foregoing claims, characterized in that the valve sealing face (24) is embodied as an annular shoulder by means of a radial narrowing of the valve member (14).
